(19) United States
(12) Patent Application Publication
(10) Pub. No.: US 2021/0165523 A1
(43) Pub. Date: Jun. 3, 2021

(54) OPTICAL SENSING TOUCH SCREEN, TOUCH DISPLAY DEVICE AND TOUCH DETECTION METHOD

(71) Applicant: BOE TECHNOLOGY GROUP CO., LTD., Beijing (CN)

(72) Inventors: Xiaoliang Ding, Beijing (CN); Xue Dong, Beijing (CN); Jing Lv, Beijing (CN); Haisheng Wang, Beijing (CN); Yingming Liu, Beijing (CN); Wei Liu, Beijing (CN); Pengpeng Wang, Beijing (CN); Yanling Han, Beijing (CN); Xueyou Cao, Beijing (CN); Ping Zhang, Beijing (CN)

(21) Appl. No.: 15/779,079

(22) PCT Filed: Sep. 28, 2017
(86) PCT No.: PCT/CN2017/103933

§ 371 Date: May 24, 2018

(30) Foreign Application Priority Data
Feb. 16, 2017 (CN) 201710083136.7

(51) Int. Cl. G06F 3/042; G06F 3/041; G09G 3/34

(52) U.S. Cl. CPC G06F 3/0421; G09G 3/3406; G06F 3/0416; G06F 3/0412

(57) ABSTRACT

An optical sensing touch screen, a touch display device and a touch detection method are provided. The optical sensing touch screen includes a plurality of touch regions, each touch region is provided with one or more optical sensing units, and the one or more optical sensing units in each touch region are connected with a touch detection chip through an independent touch-signal reading line corresponding to the touch region.

### CROSS-REFERENCE TO RELATED APPLICATION

This application is a U.S. national phase application of PCT Application No. PCT/CN2017/103933 filed on Sep. 28, 2017, which claims a priority to a Chinese Patent Application No.201710083136.7 filed in China on Feb. 16, 2017, the disclosure of which is incorporated in its entirety by reference herein.

### TECHNICAL FIELD

The present disclosure relates to the field of optical touch technologies, and in particular to an optical sensing touch screen, a touch display device and a touch detection method.

### BACKGROUND

An optical sensing touch screen in the related art generally includes a plurality of scan lines in a row direction, a plurality of touch-signal reading lines in a column direction intersecting with the scan lines, a plurality of optical sensing units and a plurality of thin film transistors (TFTs) in regions defined by the scan lines and the touch-signal reading lines intersected with the scan lines. In the row direction, one row is turned on through the thin film transistors; and in the column direction, data in the row that is turned on is read to achieve a touch positioning function.

### SUMMARY

In one aspect, the present disclosure provides an optical sensing touch screen. The optical sensing touch screen includes a plurality of touch regions, wherein each of the plurality of touch regions is provided with one or more optical sensing units, and the one or more optical sensing units in each of the plurality of touch regions are connected with a touch detection chip through an independent touch-signal reading line corresponding to the touch region.

Optionally, each of the plurality of touch regions is provided with a plurality of the optical sensing units, and output terminals of the optical sensing units in each of the plurality of touch regions are connected in parallel and are connected with the touch-signal reading line corresponding to the touch region.

Optionally, signal input terminals of the optical sensing units in all of the plurality of touch regions are connected with a same touch-signal input line.

Optionally, signal input terminals of the optical sensing units in each of the plurality of touch regions are connected with an independent touch-signal input line corresponding to the touch region.

Optionally, each of the plurality of touch regions corresponds to a plurality of sub-pixel regions used for display.

Optionally, each of the plurality of sub-pixel regions corresponds to one of the plurality of optical sensing units.

Optionally, the plurality of sub-pixel regions is divided into at least one group, and each of the at least one group corresponds to one of the plurality of optical sensing units.

Optionally, the optical sensing touch screen further includes an array substrate, wherein the plurality of optical sensing units is arranged on the array substrate.

Optionally, the array substrate includes a base substrate and a plurality of pixel electrodes on the base substrate, and the plurality of optical sensing units is arranged in a same layer as the pixel electrodes or arranged in a separate film layer different from a film layer in which the plurality of pixel electrodes is arranged.

Optionally, the optical sensing touch screen further includes a color film substrate opposite to the array substrate, wherein the color film substrate is provided with a plurality of opening regions corresponding to the plurality of optical sensing units, and the plurality of opening regions is not provided with a color filter in the plurality of opening regions.

Optionally, the optical sensing touch screen further includes an array substrate and an opposite substrate opposite to the array substrate, wherein the plurality of optical sensing units is arranged inside the opposite substrate, and each of the touch regions corresponds to a plurality of sub-pixel regions on the opposite substrate.

Optionally, the optical sensing touch screen further includes an array substrate, an opposite substrate opposite to the array substrate, and a polarizer, wherein the plurality of optical sensing units is arranged on the opposite substrate and between the opposite substrate and the polarizer, and each of the plurality of touch regions corresponds to a plurality of sub-pixel regions on the opposite substrate.

In another aspect, the present disclosure provides a touch display device. The touch display device includes the optical sensing touch screen provided above and a touch detection chip. The touch detection chip is connected with the touch-signal reading line, and is configured to obtain a touch signal transmitted in the touch-signal reading line and determine a touch position according to the touch signal.

Optionally, the touch display device further includes a backlight source and a backlight driving module. The backlight source is configured to provide, to the optical sensing touch screen, backlight rays used for touch detection. The touch detection chip further includes: a demodulation module configured to obtain a backlight driving signal outputted by the backlight driving module and obtain a frequency of the backlight driving signal; and a processing module, configured to obtain the touch signal transmitted in the touch-signal reading line, extract a signal having a same frequency as that of the backlight driving signal from the touch signal to obtain an extracted signal, and determine a touch position based on the extracted signal.

In still another aspect, the present disclosure provides a touch detection method applied in the touch display device provided above and the touch detection method includes obtaining the touch signal transmitted in the touch-signal reading line and determining a touch position according to the touch signal.

Optionally, the obtaining the touch signal transmitted in the touch-signal reading line and determining the touch position according to the touch signal includes: obtaining the backlight driving signal outputted by the backlight driving module and obtaining a frequency of the backlight driving signal; and obtaining the touch signal transmitted in the touch-signal reading line, extracting the signal having a same frequency as that of the backlight driving signal from the touch signal to obtain the extracted signal, and determining the touch position according to the extracted signal.

### BRIEF DESCRIPTION OF THE DRAWINGS

FIG. 1 is a structural schematic diagram of an optical sensing touch screen according to some embodiments of the present disclosure;

FIG. 2 is a schematic diagram of a connection manner of an optical sensing unit according to some embodiments of the present disclosure;

FIG. 3 is a structural schematic diagram of an optical sensing touch screen having an In-Cell structure according to some embodiments of the present disclosure;

FIG. 4 is a structural schematic diagram of a touch display device according to some embodiments of the present disclosure;

FIG. 5 is a structural schematic diagram of a touch detection chip according to some embodiments of the present disclosure; and

FIG. 6 is a flowchart of a touch detecting method according to some embodiments of the present disclosure.

### DETAILED DESCRIPTION

In order to make an objective, technical solutions and advantages of embodiments of the present disclosure clearer, the technical solutions of the embodiments of the present disclosure will be illustrated below clearly and completely in conjunction with drawings of the embodiments of the present disclosure. Apparently, the described embodiments are merely a part, rather than all, of the embodiments of the present disclosure. All other embodiments obtained by those skilled in the art based on the described embodiments of the present disclosure without creative efforts shall fall within the protection scope of the present disclosure.

Reference is made to FIG. 1. FIG. 1 is a structural schematic diagram of an optical sensing touch screen 1 according to some embodiments of the present disclosure. The optical sensing touch screen 1 includes a plurality of touch regions 10. At least one optical sensing unit (not shown in FIG. 1) is arranged in each of the touch regions 10, and the at least one optical sensing unit in each touch region 10 is connected with a touch detection chip 30 through an independent touch-signal reading line 20 corresponding to the touch region 10.

In the embodiments of the present disclosure, the at least one optical sensing unit in each touch region 10 is connected with the touch detection chip 30 through the independent touch-signal reading line 20 corresponding to the touch region 10. When a touch detection operation is performed, any one touch region 10 on which a finger is pressing may generate a photocurrent signal, which flows through the touch-signal reading line 20 corresponding to the touch region 10 and may be detected by the touch detection chip 30, thereby achieving the touch detection operation. Since the at least one optical sensing unit in each of the touch regions 10 is connected with the touch detection chip 30 through an independent touch-signal reading line corresponding to the touch region and does not interfere with each other, a thin film transistor is not required to function as a switch. Therefore, an aperture ratio of the optical sensing touch screen provided by the present disclose is improved, and a production cost is reduced.

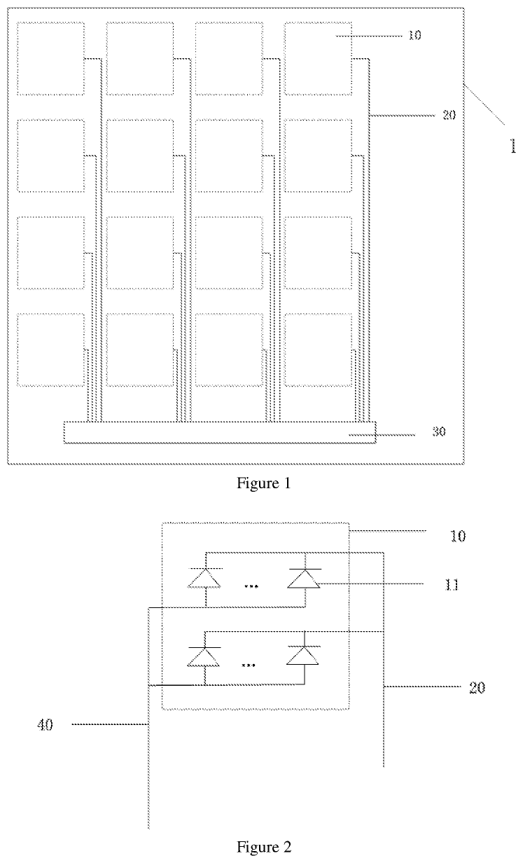

Reference is made to FIG. 2. According to the embodiments of the present disclosure, each of the touch regions 10 may include a plurality of optical sensing units 11, output terminals of the optical sensing units 11 in a same touch region 10 are connected in parallel, and are connected with the touch-signal reading line 20 corresponding to the touch region 10. The plurality of optical sensing units 11 enables a touch sensing function of each touch region 10 more sensitive.

Referring again to FIG. 2, in the embodiments of the present disclosure, signal input terminals of the optical sensing units 11 in all of the touch regions 10 are connected with a same touch-signal input line 40. A structure formed in such a manner is simple and has a short signal delay. Of course, in some other embodiments of the present disclosure, each of the touch regions 10 is connected with one touch-signal input line 40, or some of the touch regions 10 is connected with one touch-signal input line 40. A manner in which the touch regions 10 are connected with the touch-signal input line 40 may be arbitrarily designed as required.

In the embodiments of the present disclosure, each of the optical sensing units 11 may be a photosensitive diode, an input terminal of the photosensitive diode is connected with the touch-signal input line 40, and an output terminal of the photosensitive diode is connected with one touch-signal reading line 20. Of course, in some other embodiments of the present disclosure, the optical sensing units 11 may also be other types of optical sensing devices.

Since a touch region for touch detection is generally larger than one sub-pixel region used for display, each of the touch regions 10 of the optical sensing touch screen in some embodiments of the present disclosure may correspond to a plurality of sub-pixel regions used for display.

The optical sensing touch screen in some embodiments of the present disclosure may be a touch screen having an In-Cell structure, or an On-Cell structure, or an OGS (One Glass Solution) structure.

In a case that the optical sensing touch screen 1 is a touch screen having the In-Cell structure, the optical sensing units 11 may be inside an array substrate of the optical sensing touch screen 1. That is, the optical sensing touch screen 1 includes an array substrate, and each of the touch regions 10 of the optical sensing touch screen 1 corresponds to a plurality of sub-pixel regions on the array substrate.

In a case that the optical sensing touch screen 1 is a touch screen having the In-Cell structure, the optical sensing units 11 may also be inside an opposite substrate opposite to the array substrate. That is, the optical sensing touch screen 1 includes the opposite substrate opposite to the array substrate, and each of the touch regions 10 of the optical sensing touch screen 1 corresponds to the plurality of sub-pixel regions on the opposite substrate.

In a case that the optical sensing touch screen 1 is a touch screen having the On-Cell structure, the optical sensing units are on the opposite substrate and between the opposite substrate and a polarizer. That is, the optical sensing touch screen 1 includes the opposite substrate, and each of the touch regions 10 of the optical sensing touch screen 1 corresponds to a plurality of sub-pixel regions on the opposite substrate.

In a case that the optical sensing touch screen 1 is a touch screen having the OGS structure, the optical sensing touch screen 1 cooperates with a display panel to achieve a touch sensing function, and each of the touch regions 10 of the optical sensing touch screen 1 corresponds to a plurality of sub-pixel regions on the display panel.

In the embodiments of the present disclosure, optionally, each of the sub-pixel regions corresponds to one optical sensing unit 11. Such a structure may improve display uniformity and an intensity of optical sensing signals.

In some other embodiments of the present disclosure, the plurality of sub-pixel regions is divided into a plurality of groups, and each of the groups corresponds to one optical sensing unit 11.

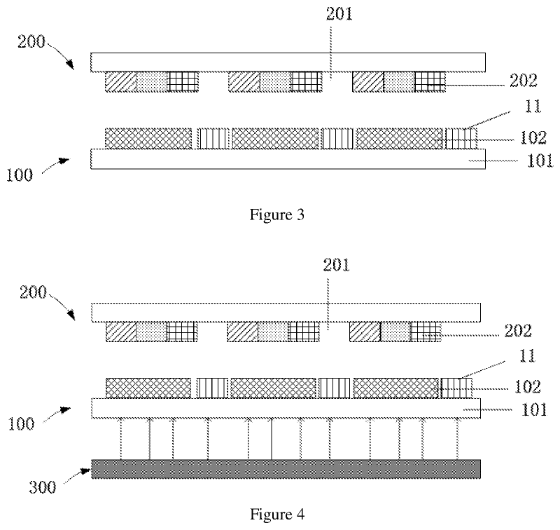

As described above, the optical sensing touch screen 1 in the embodiments of the present disclosure may be the touch screen having the In-Cell structure. Referring to FIG. 3, in the case that the optical sensing touch screen 1 is the touch screen having the In-Cell structure, the optical sensing touch screen 1 may include an array substrate 100. The array substrate 100 includes a base substrate 101 and a plurality of pixel electrodes 102. Of course, the array substrate 100 in some embodiments of the present disclosure also includes other film layers, such as a thin film transistor functional layer, and a structure of the thin film transistor functional layer is well known to those skilled in the related art, and thus will not be described repeatedly herein. The optical sensing units 11 may be arranged in a same layer as the pixel electrodes 102 on the array substrate 100.

Of course, in some other embodiments of the present disclosure, the optical sensing units 11 may also be arranged in other film layers of the array substrate 100, or may be arranged in a separate film layer.

The optical sensing touch screen 1 in some embodiments of the present disclosure may be applied in a liquid crystal display device, and performs touch detection by using rays provided by a backlight source of the liquid crystal display device. Specifically, when a finger touches the optical sensing touch screen 1, the backlight source illuminates a position of the finger, the finger reflects rays from the backlight source, the reflected rays enter the optical sensing units 11, and the optical sensing units 11 detect a change of rays, and thereby the position of the finger is detected.

Reference is made to FIG. 3. In order not to affect the touch detection, the optical sensing touch screen in some embodiments of the present disclosure further includes a color film substrate 200, and the color film substrate 200 is provided with opening regions 201 corresponding to the optical sensing units 201. A color filter 202 is not arranged in the opening regions 201, the rays from the backlight source may be incident onto the finger through the opening regions 201, and the rays reflected by the finger also enter the optical sensing units 11 through the opening regions 201.

Some embodiments of the present disclosure further provide a touch display device 3, and the touch display device 3 includes the optical sensing touch screen according to any one of the above embodiments. The touch display device 3 further includes a touch detection chip. The touch detection chip is connected to touch-signal reading lines and is configured to obtain touch signals transmitted in the touch-signal reading lines and to determine a touch position according to the touch signals.

The touch display device in some embodiments of the present disclosure may be the liquid crystal display device. The touch display device includes a backlight source and performs the touch detection by using rays provided by the backlight source. Specifically, when a finger touches the touch display device, rays from the backlight source illuminates a position of the finger, the finger reflects the rays, the reflected rays enter the optical sensing units, and the optical sensing units detect a change of rays, and thereby the position of the finger is detected.

Reference is made to FIG. 4. FIG. 4 is a structural schematic diagram of a touch display device 3 according to some embodiments of the present disclosure. The touch display device 3 in some embodiments of the present disclosure includes the optical sensing touch screen as shown in FIG. 3 and a backlight source 300. The backlight source 300 is configured to provide, to the optical sensing touch screen 1, backlight rays used for the touch detection.

When a touch detection chip in the related art processes touch signals, a data processing process is relatively complicated, and power consumption is relatively high, due to influences from light rays and heat from an external environment and a capacitance of a finger.

A backlight source in the related art implements a brightness adjustment function generally through a PWM (Pulse Width Modulation) technology, i.e., the backlight source is driven through a square wave having a certain frequency to achieve the brightness adjustment function. According to the embodiments of the present disclosure, a backlight driving signal for the backlight source is introduced into the touch detection chip, and when the touch detection chip performs an analysis on touch signals, the touch detection chip may extract a signal having a same frequency as that of the driving signal from the touch signals for further processing, and thereby the influence from other factors is eliminated.

In optional embodiments of the present disclosure, the touch display device 3 further includes a backlight driving module 301. The touch detection chip 30 further includes a demodulation module 31 and a processing module 32. The demodulation module 31 is configured to obtain a backlight driving signal outputted by the backlight driving module 301 and obtain a frequency of the backlight driving signal. The processing module 32 is configured to obtain touch signals transmitted in touch-signal reading lines, extract a signal having a same frequency as that of the backlight driving signal from the touch signals to obtain the extracted signal, and determine a touch position based on the extracted signal.

Such a detection manner may shield influence of the light rays from the external environment effectively and eliminate influence of a capacitive effect of a finger on the touch detection. Therefore, a detection result is more accurate, and a power consumption of a data processing unit is low.

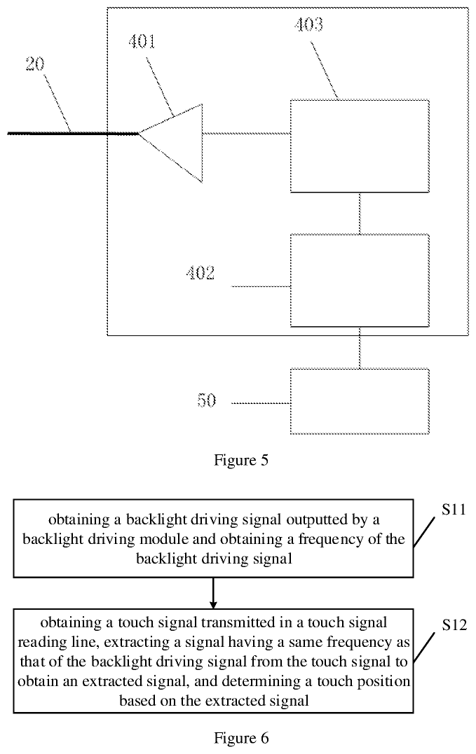

Reference is made to FIG. 5. FIG. 5 is a structural schematic diagram of a touch detection chip according to some embodiments of the present disclosure. The touch detection chip 30 includes an amplification module 401, a demodulation module 402 and a processing module 403. The amplification module 401 is connected with a touch-signal reading line 20 and is configured to amplify a touch signal transmitted in the touch-signal reading line 20 to obtain an amplified touch signal. The demodulation module 402 is connected with the backlight driving module 50 and is configured to obtain the backlight driving signal (PWM signal) outputted by the backlight driving module 50 and obtain a frequency of the backlight driving signal. The processing module 403 is configured to extract the signal having the same frequency as that of the backlight driving signal from the amplified touch signal to obtain the extracted signal, and determine a touch position based on the extracted signal.

The touch display device 3 in some embodiments of the present disclosure may be a mobile phone, a tablet computer, a personal computer, or the like.

Some embodiments of the present disclosure further provide a touch detection method, and the touch detection method may be applied in the touch display device 3. As shown in FIG. 6, the method includes a step S11 and a step S12.

Step S11: obtaining a backlight driving signal outputted by a backlight driving module and obtaining a frequency of the backlight driving signal.

Step S12: obtaining a touch signal transmitted in a touch-signal reading line, extracting a signal having a same frequency as that of the backlight driving signal from the touch signal to obtain the extracted signal, and determining a touch position based on the extracted signal.

Beneficial effects of the above technical solutions of the present disclosure are as follows. Each of the optical sensing units in each touch region is connected with the touch detection chip through an independent touch-signal reading line. When the touch detection is performed, a touch region on which a finger presses may generate a photocurrent signal, the photocurrent signal flows through a touch-signal reading line corresponding to the touch region and is detected by the touch detection chip, and thereby the touch detection function is achieved. Since the at least one optical sensing unit in each of the touch regions is independently connected with the touch detection chip and do not interfere with each other, a thin film transistor is not required to function as a switch. Therefore, an aperture ratio of the optical sensing touch screen is improved, and a production cost is reduced.

Unless otherwise defined, technical terms or scientific terms used in the present disclosure should be interpreted according to common meanings thereof as commonly understood by those of ordinary skills in the art. Such terms as “first”, “second” and the like used in the present disclosure do not represent any order, quantity or importance, but are merely used to distinguish different components. Similarly, such terms as “one”, “a” or “an” do not represent number, but only mean presence of at least one component. Such terms as “connect”, “connected” or “connecting” and the like are not limited to physical or mechanical connections, but may include electrical connections, whether direct connection or indirect connection. Such terms as “on”, “under”, “left”, “right” and the like are only used to represent a relative position relationship, and when an absolute position of a described object is changed, the relative position relationship thereof may also be changed accordingly.

The above embodiments are merely optional embodiments of the present disclosure. It should be noted that numerous improvements and modifications may be made by those skilled in the art without departing from the principle of the present disclosure, and these improvements and modifications shall also fall within the scope of the present disclosure.

1. An optical sensing touch screen, comprising:
a plurality of touch regions,
wherein each of the plurality of touch regions is provided with one or more optical sensing units, and the one or more optical sensing units in each of the plurality of touch regions are connected with a touch detection chip through an independent touch-signal reading line corresponding to the touch region.

2. The optical sensing touch screen according to claim 1, wherein each of the plurality of touch regions is provided with a plurality of the optical sensing units, and output terminals of the optical sensing units in each of the plurality of touch regions are connected in parallel and are connected with the touch-signal reading line corresponding to the touch region.

3. The optical sensing touch screen according to claim 2, wherein signal input terminals of the optical sensing units in all of the plurality of touch regions are connected with a same touch-signal input line.

4. The optical sensing touch screen according to claim 2, wherein signal input terminals of the optical sensing units in each of the plurality of touch regions are connected with an independent touch-signal input line corresponding to the touch region.

5. The optical sensing touch screen according to claim 2, wherein each of the plurality of touch regions corresponds to a plurality of sub-pixel regions used for display.

6. The optical sensing touch screen according to claim 5, wherein each of the plurality of sub-pixel regions corresponds to one of the plurality of optical sensing units.

7. The optical sensing touch screen according to claim 5, wherein the plurality of sub-pixel regions is divided into at least one group, and each of the at least one group corresponds to one of the plurality of optical sensing units.

8. The optical sensing touch screen according to claim 2, further comprising:
an array substrate, wherein the plurality of optical sensing units is arranged on the array substrate.

9. The optical sensing touch screen according to claim 8, wherein the array substrate comprises a base substrate and a plurality of pixel electrodes on the base substrate, and the plurality of optical sensing units is arranged in a same layer as the pixel electrodes, or arranged in a separate film layer different from a film layer in which the plurality of pixel electrodes is arranged.

10. The optical sensing touch screen according to claim 7, further comprising:
a color film substrate opposite to the array substrate, wherein the color film substrate is provided with a plurality of opening regions corresponding to the plurality of optical sensing units, and the plurality of opening regions is not provided with a color filter in the plurality of opening regions.

11. The optical sensing touch screen according to claim 2, further comprising:
an array substrate and an opposite substrate opposite to the array substrate, wherein the plurality of optical sensing units is arranged inside the opposite substrate, and each of the touch regions corresponds to a plurality of sub-pixel regions on the opposite substrate.

12. The optical sensing touch screen according to claim 2, further comprising:
an array substrate, an opposite substrate opposite to the array substrate, and a polarizer, wherein the plurality of optical sensing units is arranged on the opposite substrate and between the opposite substrate and the polarizer, and each of the plurality of touch regions corresponds to a plurality of sub-pixel regions on the opposite substrate.

13. A touch display device, comprising:
the optical sensing touch screen according to claim 1; and
a touch detection chip, connected with the touch-signal reading line, and configured to obtain a touch signal transmitted in the touch-signal reading line and determine a touch position according to the touch signal.

14. The touch display device according to claim 13, further comprising:
a backlight source configured to provide, to the optical sensing touch screen, backlight rays used for touch detection; and
a backlight driving module,
wherein the touch detection chip further comprises:
a demodulation circuit, configured to obtain a backlight driving signal outputted by the backlight driving module and obtain a frequency of the backlight driving signal; and
a processing circuit, configured to obtain the touch signal transmitted in the touch-signal reading line, extract a signal having a same frequency as that of the backlight driving signal from the touch signal to obtain an extracted signal, and determine a touch position based on the extracted signal.

15. A touch detection method, applied in the touch display device according to claim 13 and comprising:
obtaining the touch signal transmitted in the touch-signal reading line and determining a touch position according to the touch signal.

16. A touch detection method according to claim 15, applied in the touch display device according to claim 14, and comprising:
obtaining the backlight driving signal outputted by the backlight driving module and obtaining the frequency of the backlight driving signal; and
obtaining the touch signal transmitted in the touch-signal reading line, extracting the signal having the same frequency as that of the backlight driving signal from the touch signal to obtain the extracted signal, and determining the touch position according to the extracted signal.

17. The optical sensing touch screen according to claim 3, wherein each of the plurality of touch regions corresponds to a plurality of sub-pixel regions used for display.

18. The optical sensing touch screen according to claim 3, further comprising:
an array substrate, wherein the plurality of optical sensing units is arranged on the array substrate.

19. The optical sensing touch screen according to claim 8, further comprising:
a color film substrate opposite to the array substrate, wherein the color film substrate is provided with a plurality of opening regions corresponding to the plurality of optical sensing units, and the plurality of opening regions is not provided with a color filter in the plurality of opening regions.

20. The optical sensing touch screen according to claim 3, further comprising:
an array substrate and an opposite substrate opposite to the array substrate, wherein the plurality of optical sensing units is arranged inside the opposite substrate, and each of the touch regions corresponds to a plurality of sub-pixel regions on the opposite substrate.
